(19) United States
(12) Patent Application Publication
(10) Pub. No.: US 2017/0236234 A1
(43) Pub. Date: Aug. 17, 2017

(54) RISK MANAGEMENT METHOD AND SYSTEM FOR A LAND TRANSPORATION SYSTEM

(71) Applicant: Alstom Transport Technologies, Saint-Ouen (FR)

(72) Inventors: Fateh Guenab, Creteil (FR); Elie Soubiran, Bagnolet (FR); Eric Hautot, La Chapelle en Serval (FR)

(21) Appl. No.: 15/430,908

(22) Filed: Feb. 13, 2017

(30) Foreign Application Priority Data
Feb. 12, 2016 (FR) 1651163

(51) Int. Cl. G06Q 50/30; G06Q 10/06

(52) U.S. Cl. CPC G06Q 50/30; G06Q 10/0635

(57) ABSTRACT

A management method including identifying a list of risks and accidents that may affect the analyzed transportation system and, for each identified risk and accident, a value of an indicator representative of the impact of the risk or accident, determining a tolerable indicator value, developing at least one measure to reduce the value of the indicator such that the value of the indicator becomes lower than the tolerable indicator value, editing a risk management table associating each identified risk and accident with the reduction measure and the value of the indicator obtained based on the reduction measure, wherein the identifying, determining and editing are done automatically, and the developing the reduction measure are carried out by a user.

### CROSS REFERENCE TO RELATED APPLICATIONS

This application claims priority under 35 USC §119 of French Patent Application No. 16 51163 filed on Feb. 12, 2016.

### FIELD OF THE INVENTION

The present invention relates to a method for managing risks related to an analyzed land transportation system, comprising the following steps:
identifying a list of risks and accidents that may affect the analyzed transportation system based on a given operating state of the transportation system and, for each identified risk and accident, a value of at least one indicator representative of the impact of said risk or accident,
determining, for each identified risk and accident, an acceptable indicator value below which the safety of the transportation system can be demonstrated,
developing, for at least some of the identified risks and accidents, at least one measure to reduce the value of the indicator representative of the impact, the implementation of which makes it possible to reduce the value of said indicator for said risk and accident when said value of said indicator is above the acceptable indicator value, such that said value of said indicator becomes lower than or equal to the acceptable indicator value associated with said risk and accident,
editing a risk management table for the analyzed transportation system, said table associating each identified risk and accident with the measure to reduce the value of the indicator and the value of said indicator of said risk and accident obtained based on the reduction measure.

The invention also relates to a risk management system making it possible to carry out such a method.

The invention for example applies to a land transportation system such as a railway system, a private or shared autonomous road transportation system on a private or public site, any transportation system having driving and/or protection functions partially discharged to at least one electronic and/or computer system, whether on board or remote, or any combination of transportation systems having heterogeneous characteristics, such as a mixed tram/train system, a system for supervising a public transportation assembly or multimodal freight.

### BACKGROUND OF THE INVENTION

In the field of land transportation, risk management makes it possible to avoid accidents or incidents, or to limit the occurrence thereof, and to decrease the consequences of such accidents or incidents, in particular in terms of the transportation system user safety, equipment, or the environment, to reduce wait times in case of breakdown and economic impact for the company operating such systems.

Risk management is applied to all types of land transportation systems, ranging from a component part of a vehicle or infrastructure to an entire vehicle or infrastructure to managing the traffic of a set of vehicles, and this risk management is applied during the design and operating phases of the transportation system and until the transportation system is decommissioned.

Thus, risk management applies to quite varied systems that are nevertheless becoming increasingly interdependent (multimodality, etc.). This variety makes it difficult to implement a unified risk management method able to be applied to all types of transportation systems or combinations thereof. Indeed, there are many risks incurred by these transportation systems and accidents that may affect them, these risks and accidents not necessarily being shared by all of these systems. Furthermore, when the transportation systems involve different employees to develop and/or operate them, the risks and accidents are not necessarily identified using a consistent vocabulary, even though they may apply to several transportation systems, which makes it difficult to automate the identification of the risks and accidents that may apply to all or part of the analyzed transportation systems.

In this context, risk management related to transportation systems applies to each class of systems, each solution or system of these classes, and lastly, each deployment project for a solution potentially having different normative, environmental and operational characteristics.

Consequently, in light of these difficulties, risks related to transportation systems are generally managed on a system-by-system basis, the information related to one system class (related to a project, respectively) not being shared and sent for risk management to another system in the same class (to another deployment project for the same solution, respectively), including when the same risks and accidents may apply to these systems (these projects, respectively), which reduces the efficiency of this risk management. Lastly, no shared inter-class analysis framework exists. Furthermore, risk management is subject to little or no automation, which makes implementing risk management plans cumbersome, slow and expensive. Indeed, the person(s) responsible for developing a risk management plan must carry out all of the steps making it possible to establish this plan, identify risks and accidents that may affect the analyzed transportation system to generate a risk management table making it possible to associate measures to be taken or to verify the relevance of the measures taken in response to the identified risks and accidents. These people are also responsible, throughout the entire design cycle, for the traceability and refinement of the protection measures, whether functional, procedural, architectural, qualitative, etc. In a system context, these people must also ensure that the constraints exported and imported between the various component systems are appropriate, as well as the risks related to environmental issues shared between systems. Risk management plans are thus often developed from scratch for the various transportation systems and implemented in a rudimentary manner, for example using Excel sheets or workbooks that are difficult for people other than those who designed the risk management plans to read.

### SUMMARY OF THE DESCRIPTION

One aim of the invention is thus to propose a method for managing risks related to a transportation system that can be applied coherently to all transportation systems and that can be implemented simply and inexpensively.

To that end, the invention relates to a risk management method of the aforementioned type, in which the identification, determination and edition steps are done in an automated manner based on information entered by at least one user on the analyzed transportation system, the step for developing the measure to reduce the value of the indicator being carried out by said user.

To achieve this level of genericity, allowing the method to be applied to all transportation systems, the method is based on a systemization of three analytical methods; i.e., the inductive method, the deductive method and refinement, the whole being associated with generic metrics that can be instantiated based on a given normative context.

By automating the identification, determination and edition steps based on information entered by at least one user on the analyzed transportation system, it is possible to reuse the identified risks and accidents and the reduction measures developed for a transportation system when the same risks and accidents apply to another transportation system, which reduces the work necessary when a new risk management plan must be developed and makes it possible to optimize the reduction measures by using the experience acquired when establishing earlier risk management plans. Furthermore, the user involved in establishing risk management plans can dedicate himself primarily to the task to which he contributes a real value-added; i.e., the development of measures to reduce the value of the indicator representative of the occurrence or impact of the risks and accidents. Thus, the method according to the invention makes it possible to improve the establishment of risk management plans by making it faster, more reliable and easier to use for people other than those responsible for drawing up these plans.

According to other features of the method according to the invention:
the identification step for the list of risks and accidents comprises the following steps:
   consulting at least one database containing a table formalizing risks and accidents related to a plurality of transportation systems and a table of operational contexts and/or scenarios comprising a list of operating states in which said transportation systems may be found,
   identifying, in an at least partially automated manner, in said formalization table, the risks and accidents related to the analyzed transportation system based on information on said analyzed transportation system entered by the user and based on operating states in which the analyzed transportation system may be found;
   the analyzed transportation system is broken down into subsystems, which in turn may be broken down into subsystems, the last layer of subsystems being made up of elementary systems, characterized in that the method comprises refinement steps during which the identification, determination and development steps are carried out for each subsystem and each elementary system of the analyzed transportation system;
   the method is implemented using an online application, said online application being accessible to the users responsible for risk management and other users responsible for the development and/or validation of the transportation system and/or the operation of the transportation system, said other users being able to consult the risk management table and/or fill in the database;
   the value of the indicator representative of the impact of the risk or accident is the occurrence value of said risk or accident or the severity value of said risk or accident or the value of an indicator pre-established or specified by a normative text in a given industrial field and/or specific to a geographical zone or a combination of at least some of said values;
   the method comprises a step for inputting information on the requirements to be met for the analyzed transportation system and/or on the architecture of the analyzed transportation system, the risks and accidents that may affect the analyzed transportation system being identified based on said information;
   the method comprises a step for importing information on tests done on the analyzed transportation system and/or on its subsystems and the results of these tests, the risks and accidents that may affect the analyzed transportation system being identified and/or the measures to reduce the value of the indicator representative of the impact being developed based on said information;
   the step for determining the acceptable indicator value comprises at least one inductive risk analysis step and one deductive risk analysis step;
   at least some of the steps of the method are carried out again when the transportation system is modified and/or when a new risk or a new accident is identified, the risk management table being updated at the end of the steps newly performed.

The invention also relates to a risk management system for implementing a risk management method as described above, comprising means for storing information related to risks and accidents that may affect transportation systems and operating states of said transportation systems, means for computing values of the indicator representative of the impact of said risks and accidents based on a given operating state and measures for reducing the value of the indicator, means for a user to enter information and means for editing a risk management table for the analyzed transportation system.

According to another feature of the system according to the invention, the storage means and the computing means are placed on a server and accessible remotely using an online application.

### BRIEF DESCRIPTION OF THE DRAWINGS

Other aspects and advantages of the invention will appear upon reading the following description, provided as an example, and done in reference to the appended drawings, in which:

FIG. 1 is a schematic illustration of the architecture of the risk management system and its integration into the company architecture according to the invention;

FIG. 2 is a schematic illustration of the functional architecture of the risk management system according to the invention;

FIG. 3 is a schematic illustration of the structure of the database used in the risk management method according to the invention;

FIG. 4 is a flowchart showing the different steps of the risk management method according to the invention;

FIG. 5 is a flowchart showing the algorithm carried out during a step of the risk management method of FIG. 4; and

FIG. 6 is a flowchart of an example functional architecture used in the method according to the invention.

### DETAILED DESCRIPTION

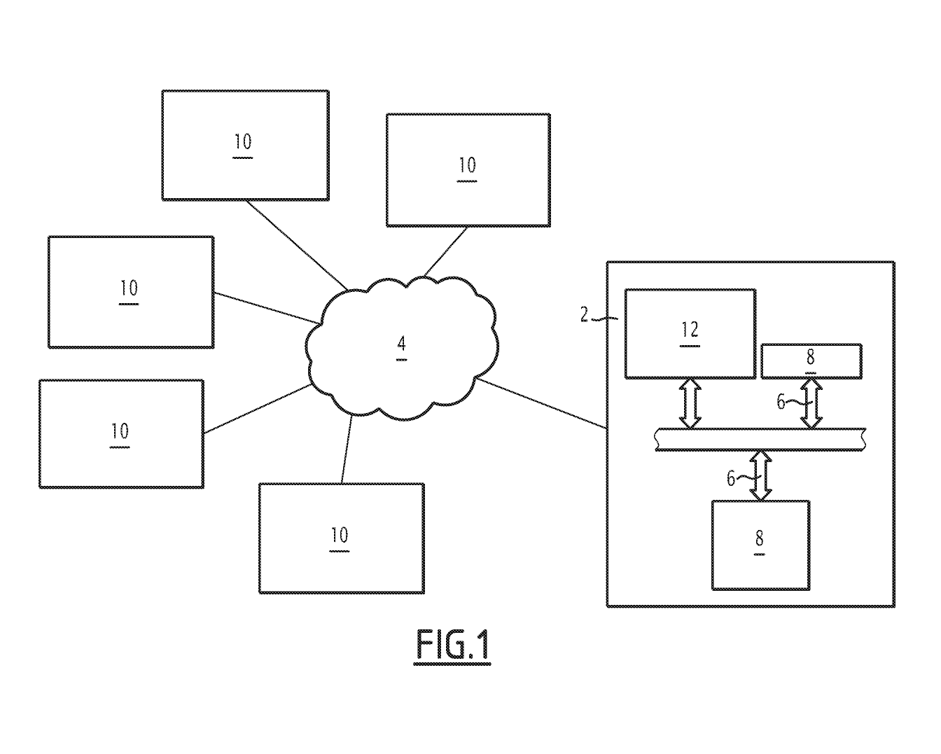

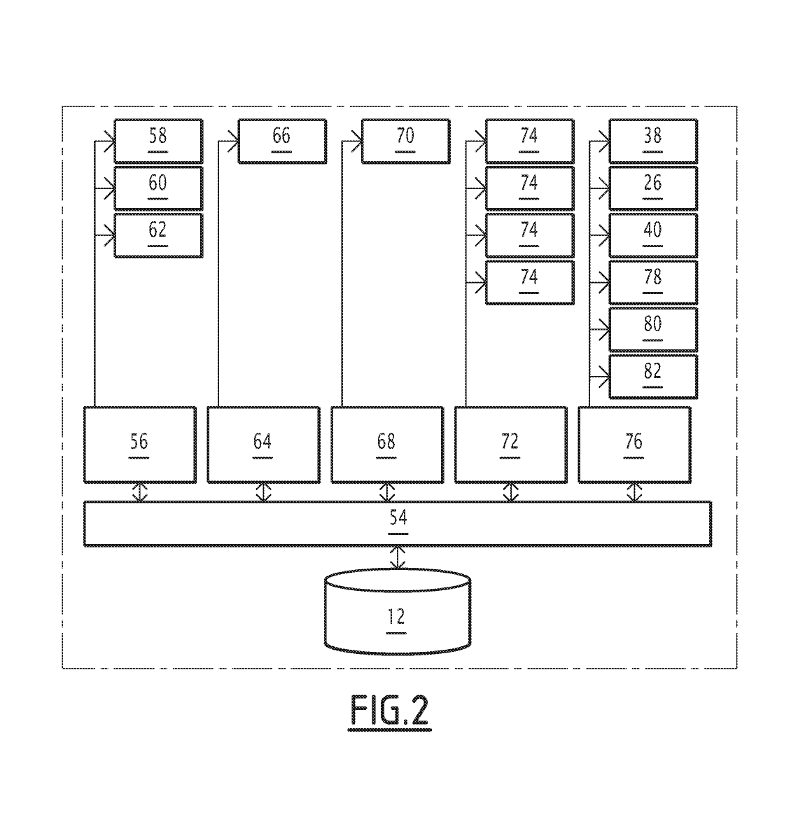

In reference to FIGS. 1 and 2, a risk management system is described making it possible to carry out a risk management method related to an analyzed transportation system in order to establish a risk management plan to be implemented during the development and use of the analyzed transportation system. The analyzed transportation system may be of any type in the land transportation field, from a single part used in a vehicle or a transportation infrastructure to an entire vehicle or transportation infrastructure, or even an entire transportation network involving at least two vehicles and at least one transportation infrastructure. The most complex transportation systems are broken down into subsystems, which in turn may comprise subsystems, the last layer of subsystems being formed by elementary systems, for example, the elementary parts making up the transportation system. In this context, the people responsible for the analyses must be able to trace and refine the identified risks at the highest level throughout the entire design and integration of the subsystems of the system. These steps must retain the characteristics of the protection measures specified at the highest level. The system and the method according to the invention will be described in reference to a specific analyzed transportation system, but it is understood that the invention applies to any transportation system and is used as a risk management system and method for all transportation systems designed and managed by the company using the system and/or method according to the invention.

The risk management system according to the invention is based on an online application able to communicate and exchange information with at least one server 2 of the company responsible for developing and using the analyzed transportation system. The online application is accessible to various employees of the company by connecting to the company's internal network 4, or intranet, this network being provided with all appropriate means for the online application to communicate and exchange information with the server 2. These exchanges for example use structured data exchange protocols and formats, such as “JavaScript Object Notation” (Json), “Open Services for Lifecycle Collaboration” (OSLC), “Resource Description Framework” (RDF), and/or others, and HTTP (HyperText Transfer Protocol) and TCP/IP (Transmission Control Protocol/Internet Protocol) protocols 6.

The application can be used for various employees within the company, in particular the people 8 responsible for risk management for the company, as well as the people 10 responsible for developing and/or operating the transportation system. These people are, for example, the people responsible for developing the transportation system, checking and validating the selected technical solutions, managing the requirements of the transportation system, managing changes to and the configuration of the transportation system and using the transportation system. The level of interaction with the application and the usable functions differ, however, depending on the person using it, as will be described later. The application assumes the form of a user-friendly and interactive webpage making it possible to enter and view information. The application in particular makes it possible to enter identifying information for the user of the application, which will determine the level of interaction that the user has with the application based on the nature of the user. Traditionally, the access rights to the various functions of the application are determined based on user profiles managed by an administrator, who can create and modify these user profiles.

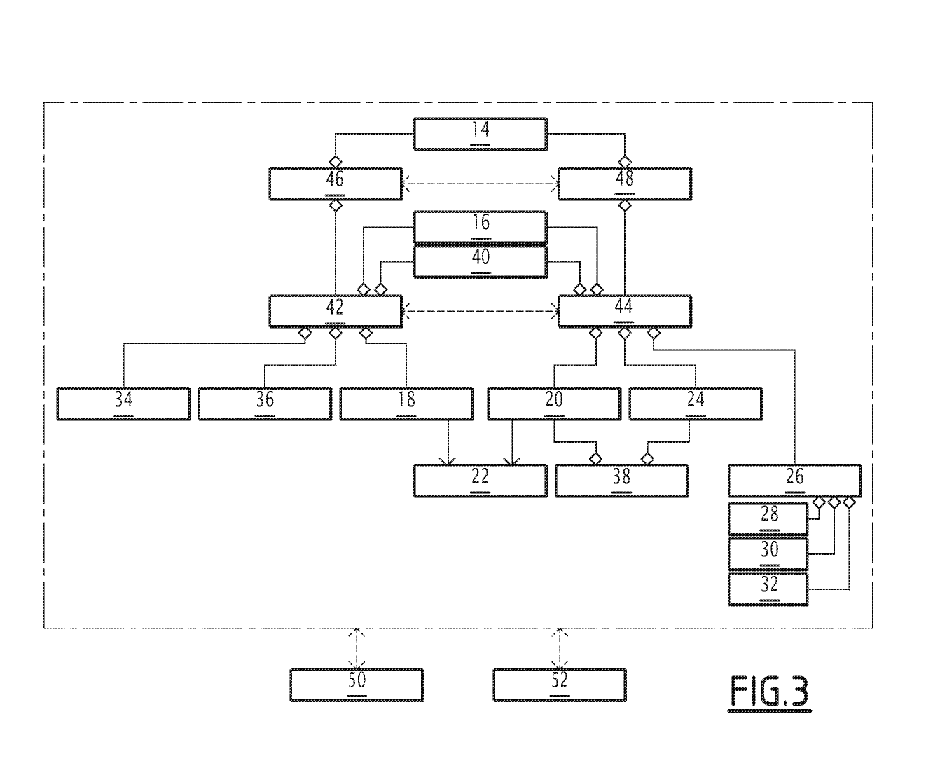

The application communicates with a database 12 stored on the server 2 and containing the various information needed to develop a risk management plan related to the analyzed transportation system as well as the information generated by the risk management method. The structure of the database 12 is shown in FIG. 3. The information is grouped together in tables specific to each type of information. Thus, the database comprises the tables relative to the following data:
user table 14, containing information relative to the users of the application,
requirements table 16, containing information relative to the analyzed transportation system and the subsystems of the analyzed transportation system,
technical risks table 18, containing information relative to the technical risks that may affect the analyzed transportation system and its subsystems,
system risks table 20, containing information relative to the risks that may affect the analyzed transportation system and its subsystems,
risks table 22, compiling the system risks and technical risks that may affect the analyzed transportation system and its subsystems,
accidents table 24, containing information relative to the accidents that may affect the analyzed transportation system and its subsystems,
operational contexts table 26, containing information relative to the different operating states of the analyzed transportation system and its subsystems, compiling information relative to the operating mode 28, the operating phase 30 and the operating zone 32,
function table 34, containing the functional architecture of the analyzed transportation system and its subsystems,
causes table 36, containing information on the causes of the risks that may affect the analyzed transportation system and its subsystems,
risks and accidents formalization table 38, making it possible to create a formal tree structure of the risks and accidents that may affect the analyzed transportation system and its subsystems,
reduction measures table 40, containing information relative to the measures for reducing the value of at least one indicator representative of the significance of the risks and accidents that may affect the analyzed transportation system and its subsystems,
system risks analysis objects table 42, compiling the information from the function 34, causes 36, technical risks 18, measures 40 and requirements 16 tables,
preliminary system risks analysis objects table 44, compiling the information from the system risks 20, accidents 24, operational 26, measures 40 and requirements 16 tables,
malfunction models tables 46 integrating, at the system level, the risk analyses conducted on each subsystem, and managing the versions of said models,
accident scenarios model 48, integrating the preliminary risk analyses 44, managing the versions of said analyses and compiling the traceability and refinement information toward the malfunction models 46,
table representing the risk monitoring register 50, and
tables for other technical elements 52 containing information on the technical elements necessary to produce the above tables.

The tables also comprise data regarding the above information relative to all of the other transportation systems previously analyzed, such that this information is accessible to develop a new risk management plan relative to the analyzed transportation system.

A software program makes it possible to cross the different tables of the database in order to carry out the steps of the method according to the invention, as indicated by the arrows in FIG. 3 and as will be described later.

The database is provided with information in various ways based on the nature of the information. Some information is entered directly by the users of the application, while other information is established automatically from entered information using algorithms for processing the entered information. The information is entered by the employees in possession of this information based on the field in which these employees are qualified. Thus, for example, information relative to the requirements of the transportation system and its subsystems supplying the requirements table 16 is entered at least by the people responsible for developing the transportation system, outside the application described here. The content of the function table 34 is supplied by the teams responsible for designing the analyzed system and its subsystems. For this type of information, software means are established on the application so as to be able to repatriate or import this information automatically.

The entered information in particular includes information relative to the identification of the user, information on the specifications of the transportation system, its subsystems and components, information on the design of the architecture of the transportation system, its subsystems and its components, information on the use of the transportation system during its operation, information on the test and validation campaigns of the transportation system, its subsystems and components, and information on the modifications or change request(s) pertaining to at least one of the preceding elements.

FIG. 2 shows the structure of the risk management system according to the invention and the interactions between the application and the database 12. A data abstraction layer 54 interacts with the database 12 in order to convert the information from the database into data usable by the application, by providing a unified interface toward the application modules based on work representations and independently of the installation of the databases. In other words, information contained in the database in multiple forms is rearranged to be shown in a format usable by the application. As an example, the data abstraction layer 54 makes it possible to project a functional architecture initially structured in the form of a hierarchical graphic and data stream oriented to a tree structure view of functions. The latter depiction is more appropriate and easier to use as part of an analysis of the “Failure Mode Effects Analysis” (FMEA) type. The abstraction layer 54 interacts with a plurality of modules forming the tools of the application and that will now be described. Each module comprises an interface making it possible to enter commands or inputs to carry out the operations set out by the module and view information so as to make each module user-friendly.

The risk management system comprises a primary module 56 managing the home page for the user of the application, its profile and the portal to the other modules of the application. This primary module 56 makes it possible, after identification of the user, to view and access the various other modules of the application based on the user's access rights, as shown by the window 58, view the user's profile as shown by the window 60, and view various notifications, such as alerts, information on risk management plan updates, etc., as shown by the window 62.

The risk management system comprises a module for managing the requirements of the analyzed transportation system 64 making it possible to manipulate the information relative to the requirements that the analyzed transportation system and its subsystems must meet.

This module 64 in particular makes it possible to create new requirements, import requirements already entered in a remote requirement management system, export the requirements to a remote requirement management system so that they may be taken into account by the system design teams, view and edit the information on the requirements of the analyzed transportation system, as shown by the window 66, and sort requirements by various search criteria to make them easier to view.

The risk management system comprises an accident scenario module 68 making it possible primarily to conduct preliminary risk analyses, as will be described later in relation to the method according to the invention. The module also makes it possible to view the performed analyses, as shown by the window 70.

The risk management system comprises a malfunction module 72 making it possible primarily to conduct preliminary risk analyses, as will be described later in relation to the method according to the invention. The methodological support is comparable to failure mode effects analyses (FMEA). This support being configurable, it allows the analysis of risks of the analyzed transportation system and its subsystems, risks relative to the interfaces of the subsystems, and risks relative to the components of the transportation system, as will be described later in relation to the method according to the invention. The module also makes it possible to view the performed analyses, as shown by the windows 74. The module also makes it possible to integrate the FMEA systems with the accident scenarios by interpreting the effects of a failure in terms of dangerous situation or risk or accident or higher-level failure.

The risk management system comprises a resources module 76 making it possible to manage the elementary resources necessary to develop risk management plans, as will be described later in relation to the method according to the invention. This module allows the creation, generation, edition and viewing of tables for risks and accidents formalization 38, operational contexts 26, reduction measures 40, risk matrices 78, likelihood 80 and severity 82 tables, preliminary analysis templates and FMEA.

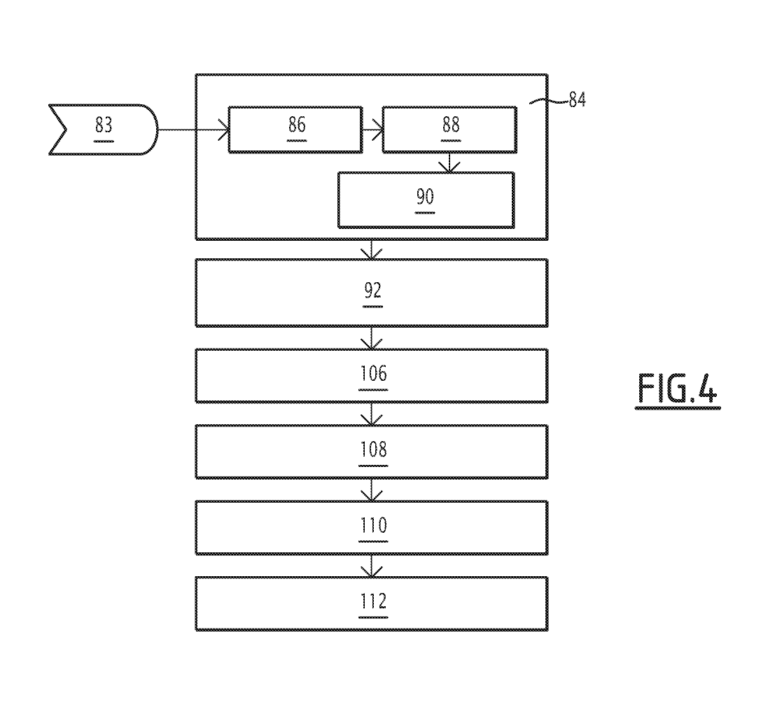

In reference to FIG. 4, the risk management method related to an analyzed transportation system is now described implementing the risk management system described above. The method will first be described for the generation of a risk management plan for a new transportation system, called analyzed transportation system, and shown by numerical reference 83 in FIG. 4.

The risk management method comprises an initial step, shown by reference 84, prior to all of the analyses done during the method. This initial step phase makes it possible to generate information that will be used during the subsequent analysis steps. It in particular involves the resources module 76 and uses the information on the analyzed transportation system, and in particular the information relative to the requirements of the transportation system and its subsystems found in the requirements table 16.

The resources module 76 recovers the library of risks and accidents that may affect a transportation system in the form of a risks and accidents formalization table 38, as shown by numerical reference 86. The resources module 76 also recovers the library of operating states in which a transportation system may be found in the form of a table of operational contexts 26, as shown by numerical reference 88. The management system also automatically generates the tools it will need to perform the subsequent analyses, such as likelihood tables, risk matrices, match tables between safety indicators (acceptable occurrence rate and safety level), risk reduction factors table, as shown by numerical reference 90.

From the above elements, the risk management system conducts a preliminary risk analysis in the form of an inductive analysis, as shown by numerical reference 92, the steps of this analysis being shown in FIG. 5. This step is carried out using the accident scenario module 68.

This module recovers the information on the analyzed transportation system, in particular on its subsystems and components, from information from the requirements table 16 using the management module for the requirements of the analyzed transportation system 64 during step 94. This table inventories the requirements that the analyzed transportation system must meet and the specifications of the analyzed transportation system, its subsystems and components.

From this information, the risk management system identifies, at least partly automatically, the risks and accidents that may affect the analyzed transportation system during step 96. “Automatically” means that the step is carried out using an algorithm generating, as result, a list of risks and accidents that may affect the analyzed transportation system from entered information and information contained in the library of risks and accidents that may affect a transportation system. More specifically, from information on the analyzed transportation system, information from the requirements table 16 and information contained in the risks table 22 and the accidents table 24 of the database 12 containing the risks and accidents identified for other transportation systems, the algorithm generates the list of risks and accidents that may affect the analyzed transportation system. This analysis is therefore inductive inasmuch as it makes it possible to identify the causes and dangerous situations starting from prior knowledge of the accidents that may affect the analyzed transportation system and the consequences.

The result of these identifications assumes the form of a risks and accidents formalization table 38 for the analyzed transportation system formally inventorying all of the risks and accidents that may affect the analyzed transportation system. It is understood that this table 38 can be updated if new risks or accidents are identified during the operation or design of the analyzed transportation system or during the operation of other transportation systems. In this case, the risks 22 and accidents 24 tables are updated, for example by the people responsible for operating the transportation systems, and the algorithm is launched again to update the risks and accidents formalization table 38 so as to account for this new information.

The management system also generates, at least partly automatically, from information on the analyzed transportation system, information from the requirements table 16 and the results of step 96, the association between the accidents or risks and the operating states in which the analyzed transportation system may be found, during step 98. The development of these states is also based on the use of information from the database on the transportation systems previously analyzed for which the operating states were identified and the associations have already been established. The operational table 26 can also be updated when new information is introduced into the database.

During step 100, the management system automatically determines, for each identified accident and risk, at least one value of at least one indicator representative of the impact of said risk or accident based on a given operating state of the analyzed transportation system, as well as an acceptable indicator value below which the safety of the transportation system can be demonstrated. Such an indicator is for example the occurrence of the identified risk or accident based on the operating state in which the analyzed transportation system is found. In this case, the acceptable indicator value is an occurrence value below which the transportation system is considered to be operating safely. Thus, it is for example considered that when a risk or accident occurs at a frequency below an acceptable frequency, this risk or accident does not present a significant danger. This determination step is for example done automatically using risk acceptability matrices. The algorithm thus makes it possible to associate each identified risk and accident with a value of the indicator representative of the impact of said risk or accident and an acceptable indicator value, and to compare these two values in order to determine whether the value of the indicator representative of the impact is greater than the acceptable indicator value. Other examples of indicators representative of the impact are the severity value of said risk or accident or the value of an indicator pre-established or specified by a normative text in a given industrial field and/or specific to a geographical zone or a combination of at least some of these values.

During a step 102, when the value of the representative indicator is greater than the acceptable indicator value, the method comprises a step for developing at least one measure to reduce the value of the indicator representative of the impact, the implementation of which makes it possible to reduce the value of said indicator for said risk and accident. This step can be carried out automatically when the identified risk or accident is already known and when an appropriate measure has already effectively been developed. When this measure is not yet known or has not demonstrated its effectiveness or is not available in the current operating state, the person responsible for risk management develops this measure and fills in the database 12 accordingly in order to generate the reduction measures table 40. During this step 102, the user has a high value-added and can use his expertise to develop the most effective possible reduction measures in order for the value of the indicator representative of the impact of a risk or accident to become less than or equal to the acceptable indicator value determined for this risk or accident. This measure will be specified using requirements pertaining to the analyzed system, or the design means used, or the exploitation procedures for the system or constraints exported to other systems. An example exported constraint may, in the railway field, be considering an autonomous train system in a context where one of the vehicles is subjected to a failure and must be rescued/towed by a locomotive suitable for repairs and that is not part of said autonomous system. In this case, the repair locomotive must couple to the broken down vehicle and take over the safety constraints initially allocated to the latter.

At the end of this step and during a risk monitoring step 103, the risk management system automatically generates a risk monitoring register associating the risk or the accident, the requirements specifying the risk reduction measure and the coverage measures (tests, inspections, etc.) implemented to ensure the proper installation of the reduction measure. At the end of this step and during a step 104, a risk management table or plan for the analyzed transportation system is edited automatically, said table associating each identified risk and accident with the operating state, the measure to reduce the value of the indicator and the value of said indicator of said risk and accident obtained based on the reduction measure, the requirements specifying the reduction measure and the version of the analysis. In the case of an indicator relative to the occurrence of the identified risk or accident, the reduction measure seeks to reduce the frequency of occurrence of the risk or accident.

This table is next made accessible in the risk management application and makes it possible to verify the thoroughness of the analysis, share the applicable requirements with the people responsible for designing the analyzed transportation system, and share the accident scenarios that will be traced and refined in the analyses 106 and 108, described below.

The system according to the invention also performs a deductive risk analysis of the system 106 using the malfunction module 72 installing a methodology of the FMEA type. The steps carried out in this method are as follows:

From the functional architecture of the system provided by the table 34, requirements of the system 16, information (analysis template, barriers) of the resources module 76, and the preliminary risk analysis 92, the system automatically generates at least part of a FMEA table.

At the end of this step, the user can edit the lines of the FMEA table:
associate a system effect represented by a risk or accident with an identified failure
associate a risk reduction barrier with the cause and/or a risk reduction barrier with the effect
associate requirements specifying the risk reduction measure(s) The system automatically checks, for each line of the FMEA, that the value of the inherited acceptable indicator of the system effect is correctly covered by the barrier(s) associated with the failure.

At the end of these steps, the system updates the risk monitoring register, and makes the results of the analyses available, which will be traced and refined in subsystem analyses 110.

Substantially similarly to what has been described for the deductive risk analysis 106, the system according to the invention also performs risk analyses related to the interfaces of the system 108 using the malfunction module 72 installing a methodology of the FMEA type. The steps are identical to those described for the deductive risk analysis of the system 106, aside from the fact that the system is based on the definition of the interfaces of the system and not on its functional architecture in order to generate the FMEA table.

Substantially similarly to what was described for the deductive risk analysis 106, the system according to the invention also performs risk analyses of the subsystems 110 using the malfunction module 72. The failures of the subsystems result in failures of the system functions or failures of the system interfaces; the risk management system automatically checks that the protection means (barriers) are correctly allocated and refined in the subsystems. This refinement step therefore makes it possible to ensure that the analyses done for the analyzed transportation system are consistent with the analyses done for each of the subsystems of the transportation system, these analyses being done for all of the subsystems, down to the elementary systems.

The results of the above analyses are compiled in order to certify that the hypotheses posited during the preliminary analysis on the tolerable accident rates are achieved by the designed system and the results are made accessible so as to form a risk management plan that can be viewed by all of the teams participating in the design of the transportation system.

This management plan is updated upon each change request applicable to the transportation system and affecting the conducted analyses, for example when the transportation system is modified or when new requirements must be met, or when a new risk or accident is identified. In one of these cases, the application conducts an impact analysis basing itself on the traceability links existing between objects in the database, the relevant analyses are done again on the affected objects, and the management plan is updated accordingly. Alerts can then be issued in order to inform the relevant people of this update.

The invention will now be explained using a concrete example of a transportation system to be analyzed. The example pertains to the railway field and relates to an automatic subway signaling system.

Proposed in this example are: a concrete definition of the manipulated object, the definition of the various indicators, the analysis templates, the elements for traceability and refinement of the risk, as well as examples of accident, operational contexts, failures and the like. The example will voluntarily be limited to the first two steps of the method.

The following table provides an example of accident classifications related to dangerous situations:

| | | Severity of | | | |
|---|---|---|---|---|---|
| Accident | | the | Accident | Risk on | Technical |
| class | Accident | accident | rate (AR) | the track | risk |
| 1. Impact | Fall on the rails | Catastrophic | rare | Platform | Incorrect |
| with a | | | | doors open | train |
| passenger | | | | with no | detection |
| or a | | | | train in | and |
| maintenance | | | | station | localization |
| worker | | | | | |
| 2. Impact | The passage | Catastrophic | Occasional | The train | The train |
| with a | may be | | | doors are | doors are |
| passenger | jammed | | | open, but | open, but |
| or a | between the | | | the | the platform |
| maintenance | doors on the | | | platform | doors are |
| worker | platform and | | | doors are | closed |
| | the train | | | closed | |

The barriers making it possible to limit the frequency of the above accidents are for example:
the protection system of the train
the installation procedure
the maintenance procedure
the infrastructure (landing door, presence sensor or the like)

The operational contexts in which these accidents may occur are for example formed by a combination of the following fields:
Operating mode of the train: automatic, monitored, not communicating (downgraded), etc.
Phase of the train: operating, maintenance, stop, etc.
Zone or localization of the train: depot, tunnel, platform, station, etc.

The indicator representative of the impact of the accident is for example the TAR (tolerable accident rate). This rate is defined from the accident rate and its severity, provided in the preceding table. For example, an accident having a catastrophic severity and an occasional rate (10⁻⁵/h, i.e., an accident occurring at a frequency of 0.00001 times per hour) is unacceptable and the aim to be achieved is an acceptable occurrence rate greater than 10⁻⁹/h.

The following table provides an example of a tolerance matrix for the risk detected and interpreted in the risk management system:

| Risk tolerance matrix | | | Severity category | | | |
|---|---|---|---|---|---|---|
| | TAR | | catastrophic | critical | marginal | insignificant |
| Frequency | frequent | greater than | unacceptable | unacceptable | unacceptable | unacceptable |
| category | | 10⁻¹/h | | | | |
| | likely | comprised | unacceptable | unacceptable | unacceptable | undesirable |
| | | between 10⁻³/h | | | | |
| | | and 10⁻¹/h | | | | |
| | occasional | comprised | unacceptable | unacceptable | undesirable | tolerable |
| | | between 10⁻⁵/h | | | | |
| | | and 10⁻³/h | | | | |
| | exceptional | comprised | unacceptable | undesirable | tolerable | negligible |
| | | between 10⁻⁷/h | | | | |
| | | and 10⁻⁵/h | | | | |
| | unlikely | comprised | undesirable | tolerable | negligible | negligible |
| | | between 10⁻⁹/h | | | | |
| | | and 10⁻⁷/h | | | | |
| | implausible | less than or | tolerable | negligible | negligible | negligible |
| | | equal to 10⁻⁹/h | | | | |

The THR (tolerable hazard rate) is defined as the residual risk rate following the combination of the TAR and a RRF (risk reduction factor), which is defined as a combination of the effectiveness of the barrier and specific conditions of the operational context.

As an example, in the “operating, in station, and automatic mode” context, the RRF of the “train protection system” barrier is at the “exceptional” level (factor 10⁵).

Below, an example accident scenario is described deduced from the inductive analysis:

Accident (1) from the accident classification table is considered in the “operating, in station, and automatic mode” context. The risk tolerance is then unacceptable according to the risk tolerance matrix and the TAR must reach the “implausible” level. By associating the “train protection system” barrier, we obtain a THR of 10⁻⁵/h allocated to the “incorrect train localization data” dangerous situation. A typical requirement associated with the barrier in this scenario is: “the train protection system must ensure that the landing doors and the doors of the train are properly aligned”; this requirement is at the maximum safety level (SIL 4 according to railway standards).

As the inductive analysis progresses, the management system automatically performs the following operations:
Prefilling scenarios: accidents, dangerous situation, characteristics (severity, rate, acceptable rate)
Potential associations of contexts and applicable barriers based on pre-existing associations
Calculations of the THR, safety level of the requirements
Formatting this information for a human user
Verifying the thoroughness of the scenarios

The management system also automatically handles the following operations:
Importing system requirements
Importing operational scenarios from system specifications (makes it possible to infer associations between context and barrier)
Exporting the new requirements resulting from the specialization of the barriers to a remote requirements referential (for example, IBM Doors)
Exporting the “export constraints” identified for the stakeholders (other systems, system operators, etc.) to a remote requirements referential
Exporting a formal model of the accident scenarios able to be simulated in the form of a transition system (for example, automaton in Altarica language, etc.)
Exporting the analysis in the form of a table formatted for certification needs

The second step consists in conducting the deductive analysis based on the functional architecture of the analyzed system, the functional requirements, a FMEA analysis template, a set of known barriers and the inductive analysis described below.

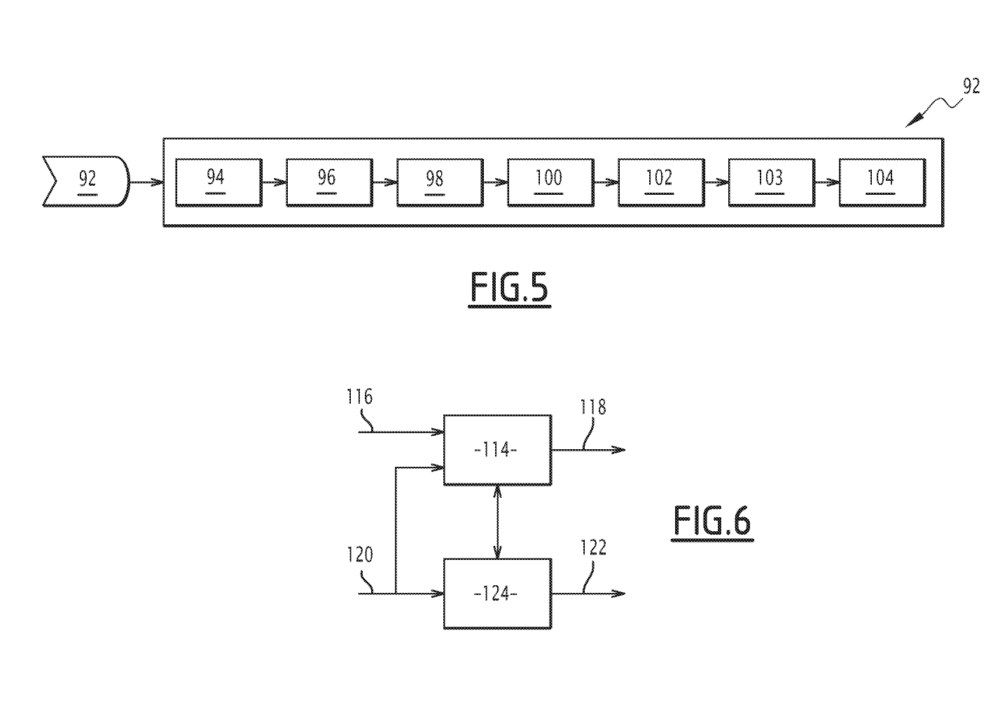

An example functional architecture is provided in FIG. 6, in which numerical references 114, 116, 118, 120, 122 and 124 respectively designate the door protection function (114), the train localization input (116), the door inspection output (118), the door status input (120), the door command output (122) and the door command function (124). The door protection 114 and door command 124 functions form the sub-functions of a root function referred to as “train door management function”.

The FMEA analysis is characterized by the application of a failure template based on predefined malfunction states of the outputs of each function. For example, the predefined states can be “incorrect”, “empty”, “too late”, etc.

The risk management system automatically pre-fills the analysis table by going through all of the functions and, for each atomic function, establishing the failure modes by applying the pre-established malfunction states for each output, as shown in the table below, as an example for certain failure modes only:

| | | |
|---|---|---|
| function | output | failure mode |

F1 Train door management function
F1.1 Train door command function

| | | |
|---|---|---|
| F1.1 | Door command | Door command |
| | output | output is incorrect |
| F1.1 | Door command | Door command |
| | output | output is empty |

F1.2 Train door protection function

| | | |
|---|---|---|
| F1.2 | Door inspection | Door inspection |
| | output | output is incorrect |
| F1.2 | Door inspection | Door inspection |
| | output | output is empty |

Each failure mode must then be associated with a system impact. This means the selection of a scenario from the inductive analysis. In this example, the failures of the command function will be traced to the “Train doors are open but platform doors are closed” dangerous situation; the failures of the protection function will be traced toward the failure of the barrier of the scenario.

By basing itself on this association and the safety level assigned to the functions, the risk management system checks that the THR on the dangerous situation is reached. Otherwise, the person responsible for risk management must specify a protection barrier on the cause of the failure (for example, protect against incorrect calculation). In case of a failure affecting a barrier, the risk management system checks that the safety level assigned to the function is compatible with the effectiveness of the barrier specified in the inductive analysis. If not, the risk management system will propose the minimum required safety level to ensure compatibility.

As the deductive analysis progresses, the management system automatically performs the following operations:
Pre-filling the FMEA analyses: functions, failure modes (fm)
Potential associations of fm's and system impacts based on pre-existing associations
Verification of the THR and safety level of the requirements and functions
Verification of the effectiveness level of the barrier on the cause
Formatting this information for a human user
Verifying the thoroughness of the FMEA analysis
Verifying the thoroughness of the deductive analysis in light of the inductive analysis and vice versa (total coverage)

The management system also automatically handles the following operations:
Importing requirements and the functional architecture of the system
Importing traceability links between the functions and the operational scenarios from system specifications (makes it possible to infer associations between fm and accident scenario)
Exporting the new requirements resulting from the specialization of the barriers or new safety levels to a remote requirements referential (for example, IBM Doors)
Exporting a formal model able to be simulated of the dysfunctional behavior of the functions in the form of a transition system (for example, automaton in Altarica language, etc.)
Exporting the analysis in the form of a table formatted for certification needs

The invention described above makes it possible to produce risk management plans in a consistent and formalized manner irrespective of the analyzed railway system. Additionally, by systematically feeding the database, most of the steps of the risk management method can be carried out automatically and only involve the people responsible for risk management when their expertise is required, which makes it possible to save time and increase efficiency, and reduces risk management-related costs.

1. A method for managing risks related to an analyzed land transportation system, said risk management method being implemented by a risk management system comprising means for storing information related to risks and accidents that may affect transportation systems and operating states of said transportation systems, means for computing values of the indicator representative of the impact of said risks and accidents based on a given operating state and measures for reducing the value of the indicator, means for a user to enter information and means for editing a risk management table for the analyzed transportation system, said method comprising the following steps:
identifying a list of risks and accidents that may affect the analyzed transportation system based on a given operating state of the transportation system and, for each identified risk and accident, a value of at least one indicator representative of the impact of said risk or accident;
determining, for each identified risk and accident, an acceptable indicator value below which the safety of the transportation system can be demonstrated;
developing, for at least some of the identified risks and accidents, at least one measure to reduce the value of the indicator representative of the impact, the implementation of which makes it possible to reduce the value of said indicator for said risk and accident when said value of said indicator is above the acceptable indicator value, such that said value of said indicator becomes lower than or equal to the acceptable indicator value associated with said risk and accident; and
editing a risk management table for the analyzed transportation system, said table associating each identified risk and accident with the measure to reduce the value of the indicator and the value of said indicator of said risk and accident obtained based on the reduction measure,
wherein the identification, determination and edition steps are performed in an automated manner based on information entered by at least one user on the analyzed transportation system, the step for developing the measure to reduce the value of the indicator being carried out by said user.

2. The risk management method according to claim 1, wherein the identification step for the list of risks and accidents comprises the following steps:
consulting at least one database containing a table formalizing risks and accidents related to a plurality of transportation systems and a table of operational contexts and/or scenarios comprising a list of operating states in which said transportation systems may be found; and
identifying, in an at least partially automated manner, in said formalization table, the risks and accidents related to the analyzed transportation system based on information on said analyzed transportation system entered by the user and based on operating states in which the analyzed transportation system may be found.

3. The risk management method according to claim 2, wherein the method is implemented using an online application, said online application being accessible to the users responsible for risk management and other users responsible for the development and/or validation of the transportation system and/or the operation of the transportation system, said other users being able to consult the risk management table and/or fill in the database.

4. The risk management method according to claim 1, wherein the analyzed transportation system is broken down into subsystems, which in turn may be broken down into subsystems, the last layer of subsystems being made up of elementary systems, wherein the method comprises refinement steps during which the identification, determination and development steps are carried out for each subsystem and each elementary system of the analyzed transportation system.

5. The risk management method according to claim 1, wherein the value of the indicator representative of the impact of the risk or accident is the occurrence value of said risk or accident or the severity value of said risk or accident or the value of an indicator pre-established or specified by a normative text in a given industrial field and/or specific to a geographical zone or a combination of at least some of said values.

6. The risk management method according to claim 1, wherein it comprises a step for inputting information on the requirements to be met for the analyzed transportation system and/or on the architecture of the analyzed transportation system, the risks and accidents that may affect the analyzed transportation system being identified based on said information.

7. The risk management method according to claim 1, wherein it comprises a step for importing information on tests done on the analyzed transportation system and/or on its subsystems and the results of these tests, the risks and accidents that may affect the analyzed transportation system being identified and/or the measures to reduce the value of the indicator representative of the impact being developed based on said information.

8. The risk management method according to claim 1, wherein the step for determining the acceptable indicator value comprises at least one inductive risk analysis step and one deductive risk analysis step.

9. The risk management method according to claim 1, wherein at least some of the steps of the method are carried out again when the transportation system is modified and/or when a new risk or a new accident is identified, the risk management table being updated at the end of the steps newly performed.

10. A risk management system for implementing a risk management method according to claim 1, comprising means for storing information related to risks and accidents that may affect transportation systems and operating states of said transportation systems, means for computing values of the indicator representative of the impact of said risks and accidents based on a given operating state and measures for reducing the value of the indicator, means for a user to enter information and means for publishing a risk management table for the analyzed transportation system.

11. The risk management system according to claim 10, wherein the storage means and the computing means are placed on a server and accessible remotely using an online application.
